(19) United States
(12) Patent Application Publication
(10) Pub. No.: US 2022/0222738 A1
(43) Pub. Date: Jul. 14, 2022

(54) System to virtually view an environment or products inserted in an environment and process thereof

(71) Applicant: Gian Marcello Noia, Genova (IT)

(72) Inventor: Gian Marcello Noia, Genova (IT)

(21) Appl. No.: 17/614,514

(22) PCT Filed: May 28, 2020
(86) PCT No.: PCT/IB2020/055053

§ 371 Date: Nov. 27, 2021

(30) Foreign Application Priority Data
May 29, 2019 (IT) 102019000007482

(51) Int. Cl. G06Q 30/06; G06Q 90/00

(52) U.S. Cl. CPC G06Q 30/0643; H04L 51/42; G06Q 90/20

(57) ABSTRACT

System and related method, to virtually view an environment or products located in an environment containing the following devices: at least two local stations, the first local station containing a local PC with appropriate peripheral devices or a tablet, the second local station containing a local PC with appropriate peripheral devices or a tablet or a screen; and a web server containing the virtual environment system with a system that transmits and receives data and mail.

The present invention relates to a system for virtually viewing an environment or products placed in an environment and the relative process.

Currently, if you want to have a customer view a product, a factory, a transformation process, an apartment, or have them check and discuss the progress of a project, it is necessary to bring the customer on site to be able to provide him with the necessary information.

We have designed a system and the related procedure that enables to provide a real presence in a virtual world by exploiting the existing 360° image technology, without the need to view the object in question on the spot, using a PC or tablet or a viewer for virtual reality, now available everywhere at very low prices.

In practice, if a manager, whether he is a salesperson and/or a technician, needs to view something that is placed in an environment, thanks to the system and the procedure object of the present invention, he can easily do so by virtually immersing himself on the spot with a customer accompanying him on the visit as if he were actually in that place. And in case the customer needs to participate with his technicians and/or guests, he can easily invite all the people he wants to the session, without having to physically bring everyone together in the place in question.

It is useless to underline the advantages that are obtained both in saving time and in economic savings due to the eliminated or at least enormously reduced need to physically go to the place in question, all assisted by a manager who in real time illustrates, explains and answers questions of the customer.

In addition, in certain situations a first virtual vision enables to quickly decide for the customer without making him spend additional time or let the manager spend it: for example in the case of environments the virtual vision of a shed, an apartment, a villa or a home may sometimes enables to quickly decide not to be interested or, on the contrary, to speed up the process of buying or renting (at this point followed by a possible inspection but with a fair possibility of sale or rent).

In fact, very often the customer visits more environments and more products, while in this way he would be able to sort more quickly what he is interested in without having to move.

The system, object of the invention, for virtually viewing an environment or products placed in an environment, contains or essentially comprises the following devices:
at least two local stations containing the first at least one local PC with suitable devices or at least one tablet, the second at least one local PC with suitable devices or at least one tablet or at least one viewer;
a WEB server containing the virtual environment system with means for transmitting receiving data and for transmitting/receiving mail.

The first station is the one available to the manager, while the second is the one available to the customer.

In this case, there may be additional workstations identical or similar to the first or second in the event of simultaneous use by other managers or customers respectively.

In particular, the at least two local stations could contain a local PC with suitable memory, a monitor, a keyboard, a mouse, a touch-screen and means for data transmission/reception.

The WEB server preferably comprises the following devices:
a central processor or central processing unit (CPU)
a graphics processor or Graphics processing unit (GPU)
an image signal processor (ISP)
Link commands for links to another page (LINK)
Memory or memories for programs, images, texts,
Video (VIDEO)
Means for sending images/data from the server to local stations (OUTPUT);
Means for sending instructions from local stations to the server (INPUT).

A further object of the present invention is the process for virtually viewing an environment or products placed in an environment, by means of the system described above, which method essentially comprises the following steps:
accessing by a manager (employee or salesman) of the company to a web page created specifically for the company itself where there are various environments corresponding to what the manager wants to show the customer;
choosing a specific environment selected by the manager and the consequent link by e-mail to person, the customer, who must view the said environment or products so that they can directly access the virtual environment;
viewing the environment or said products by the customer through the link received from the manager;
selecting by the customer of details of environments or products by means of suitable commands so as to be able to view in greater detail all the allowed areas of the environment or of the selected product,
   this process being carried out both by enabling the customer to communicate directly with the manager and by enabling the manager to see in real time, in a specific frame of his monitor, what the customer is currently seeing.

The manager at any time may have the right to be able to enable and/or disable some detailed vision functions or data available to the customer.

The web page, which is created ad hoc for the company, can contain a series of 360° pictures or render if it were a 3D.

During the procedure according to the invention, the manager can:
choose to take the customer around through a pre-established route with arrows;
take the customer to a specific area of a property, structure or process by clicking directly on the diagram or technical diagrams;
take the customer around, in the case of a visit, through points within the photograph itself;
take notes and record them;
recall technical characteristics visible only to him;
launch a 360° video and comment it in real time, with the possibility of including normal pictures, texts and audio within the 360° picture.

Also during the procedure, within the environment, the manager can draw attention to a detail: in this case, for example by clicking on the image, an arrow will appear in the client's monitor or viewer that suggests that he shall move along the desired direction.

Of course, the customer can also click and interact in this way with the manager to draw his attention, for example, to a detail.

In special cases, the customer's second workstation could also be located in the same offices as the manager, for example in the case of companies that sell products for other companies.

These and other characteristics and advantages of the present invention will become clearer from the following description of some embodiments illustrated in the attached drawings wherein:

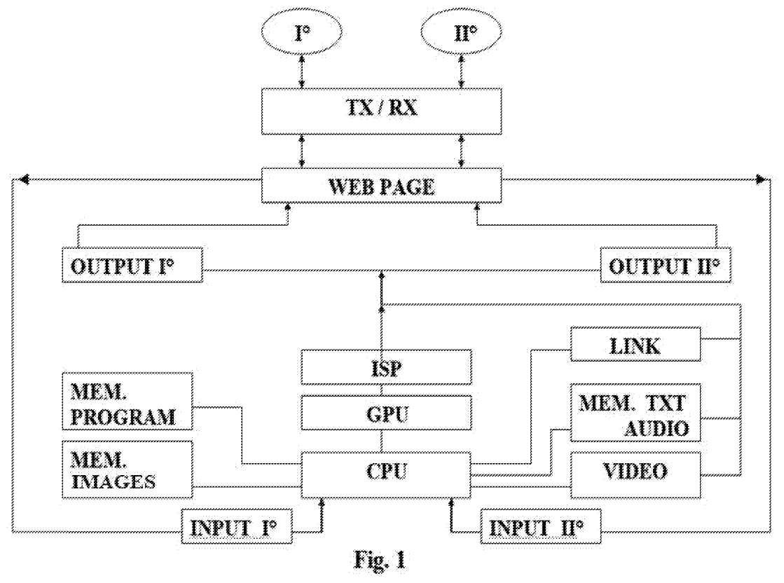

FIG. 1 shows the Web Server system;

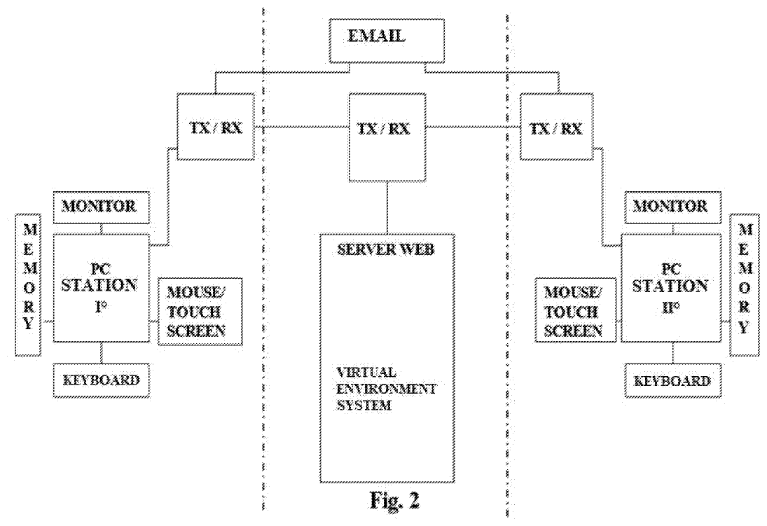

FIG. 2 shows the system comprising two local workstations, the first one of the manager and the second one of the customer, connected to the Web Server;

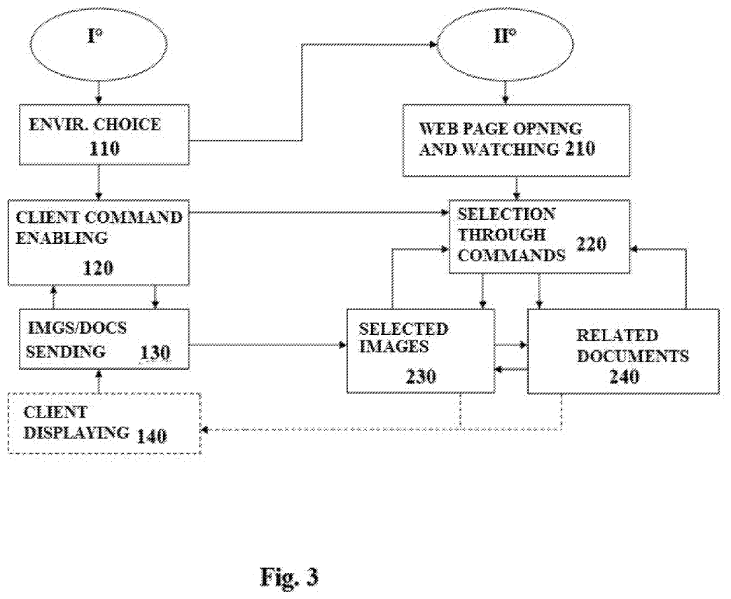

FIG. 3 shows one of the possible block diagrams of the process;

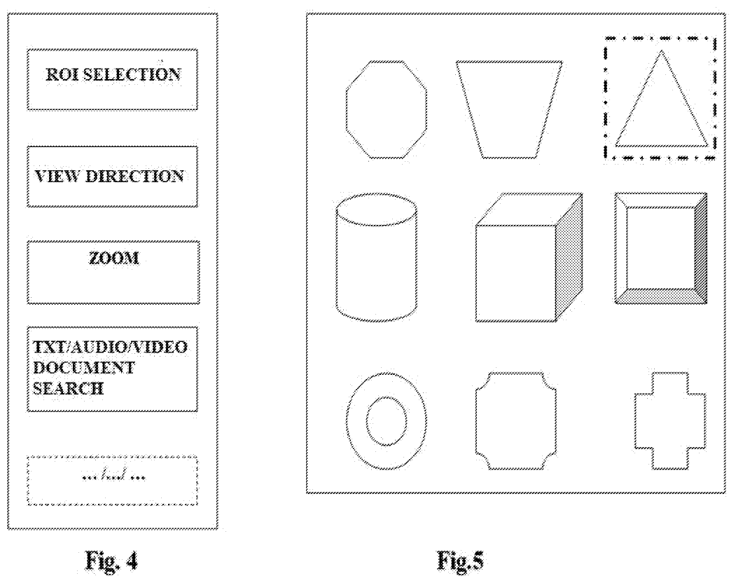

FIG. 4 shows a possible selection of the commands available to the customer;

FIG. 5 shows a ROI (Region Of Interest) selection available to the customer;

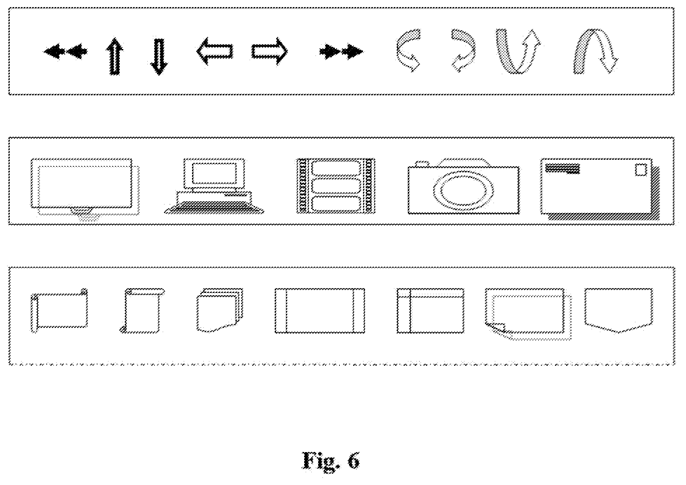

FIG. 6 shows possible command bars available to the customer or manager.

In FIG. 1 shows the WEB SERVER which contains:
a central processor or central processing unit (CPU)
a graphics processor or graphics processing unit (GPU)
an image signal processor (ISP)
Link commands for links to another page (LINK)
Program memories (MEM.PROGRAM), images (MEM.IMAGES), audio texts (MEM TXT AUDIO)
Video (VIDEO)
Means for sending images/data from the server to local stations (OUTPUT);
Means for sending instructions from local stations to the server (INPUT).

The images/data (TX/RX) from the server through the OUTPUT means reach the stations of the manager (I°) and the customer (II°) through a WEB PAGE.

Both the manager and the customer can select the respective commands, defined differently for the two stations, in order to send the desired instructions (INPUT I°) and (INPUT II°) respectively to the server.

In FIG. 2 shows the system comprising the two stations, that of the manager (I°) and that of the client (II°) connected to the Web Server. Both the manager's station (I°) and the client's station (II°) can include:
a LOCAL PC,
a MONITOR,
a KEYBOARD,
one or more MEMORIES,
a MOUSE and/or TOUCH-SCREEN
transmitting/receiving means (TX/RX).

These stations both communicate with the WEB SERVER through the transmitting/receiving means and possibly with a MAIL channel.

FIG. 3 shows a block diagram of the procedure where the manager (I°) accesses a web page, created specifically for the company, where he can find the various environments corresponding to what the manager wants to show the customer. He chooses the virtual environment to be viewed (Environment choice) (110) and sends an email to the customer with a link to directly access the virtual environment.

The manager can change the commands available to the customer based on the minimum or maximum information that he prefers to provide to the customer himself (Enable commands) (120).

The customer (II°), after opening the linked web page (Opening and viewing the web page) (210) can view the virtual environment and through available commands (Select by commands) (220) can decide to move, enlarge the selected area where he is most interested (Visions selected) (230) and possibly view the related documentation (TXT, Audio, Video) (Related documents) (240).

The manager can always see in real time what the customer is in particular seeing at that moment (Customer display) (140) (for example through a window on the monitor), while leaving the customer at the same time complete freedom of movement: in this way he may intervene or provide verbal clarifications and/or further related documentation to clarify/specify particular requests and/or make some choices of positioning details in order to help or direct the customer (Sending visions documents) (130).

FIG. 4 shows a possible selection of the commands available to the customer in which the customer can for example make a selection of one of the objects (ROI SELECTION), a direction of view (DIRECTION OF VIEW), an enlargement of the product or area (ZOOM), or consult/download documentation (TX/AUDIO/VIDEO DOCUMENT SEARCH) or other commands.

In FIG. 5 the ROI (Region Of Interest) selection is made, for example, by selecting one of the objects in the monitor through the frame (which are represented in the figure with solids and geometric figures only for simplicity).

FIG. 6 shows three possible types of command bars, the first one to choose the direction of view by means of arrows, the second one to choose the means for storing data and the third one to choose the viewable documentation available.

The invention claimed is:

1. A system to virtually view an environment or products located in an environment containing the following devices:
at least two local stations, of which a first local station contains at least one local PC with peripheral devices or at least one tablet, and a second local station contains at least one local PC with peripheral devices, at least one tablet, or at least one screen; and
a web server containing a virtual environment system, the web server being configured to transmit and receive data and to transmit and receive mail.

2. The system according to claim 1, wherein the web server comprises the following devices:
a central processor or central processing unit (CPU);
a graphics processor or graphics processing unit (GPU);
an image signal processor (ISP);
link commands for links to another page (LINK);
memory or memories for programs images and texts;
a video device (VIDEO);
means for sending images/data from the web server to the at least two local stations (OUTPUT); and
means for sending instructions from the at least two local stations to the web server (INPUT).

3. A process to virtually view an environment or products located in an environment, using a system according to claim 1, the process comprising:
accessing, by a manager of a company, a web page created ad hoc for the company, the web page containing various environments corresponding to an environment the manager wants a customer to see;
selecting a virtual environment selected by the manager and a link to the virtual environment via email to the customer interested in said virtual environment or products in said virtual environment so that the customer is enabled to directly access the virtual environment;
viewing, by the customer, said virtual environment or said products by way of the link received from the manager; and
selecting, by the customer, specific environments or products by way of appropriate commands so as to be able to view all of accessible areas of the specific environment or product in a more extensive way,
said process being carried out both by allowing the customer to communicate directly with the manager and allowing the manager to view, in a given box of the manager's monitor in real time, what the customer is seeing at that moment.

4. The process according to claim 3, wherein the manager has a power of enabling and/or disabling at any time specific detailed viewing functions or data available to the customer.

5. The process according to claim 3, wherein, during the process, the manager can:
choose to guide the customer through a predetermined path with arrows;
guide the customer in a specific area of a building, structure or process by clicking directly on a technical scheme or schemes of the building, structure or process;
guide the customer, in case of a visit, through points inside a picture;
take notes and record the notes;
recall technical characteristics only the manager can see; and
launch a 360° video and comment on the 360° video in real time, and inserting pictures, texts and audio inside the 360° video when desired.
